(19) United States
(12) Patent Application Publication
(10) Pub. No.: US 2026/0145273 A1
(43) Pub. Date: May 28, 2026

(54) SYSTEM AND METHOD FOR APPLYING A LASER TREATMENT TO AN ELECTRONIC DEVICE

(71) Applicant: Communications Test Design, Inc., West Chester, PA (US)

(72) Inventors: Andrew GINIEWSKI, Gilbertsville, PA (US); Chris MANDEEN, West Chester, PA (US); Ryan SMITH, Boothwyn, PA (US); Victor F. MAZZIO, West Chester, PA (US); Stephen DIJOSEPH, Downingtown, PA (US)

(73) Assignee: Communications Test Design, Inc., West Chester, PA (US)

(21) Appl. No.: 18/956,110

(22) Filed: Nov. 22, 2024

(51) Int. Cl. B23K 26/352; B23K 26/062; B23K 26/10

(52) U.S. Cl. CPC B23K 26/355; B23K 26/062; B23K 26/10

(57) ABSTRACT

A system and method for applying a laser treatment to an electronic device is shown and described. The method for applying a laser treatment to an electronic device includes determining the electronic device type. Determining the laser treatment type based on the device type. The laser treatment type is comprised of the laser's power, the laser distance from the electronic device, the lasers wavelength and the pattern of laser application along the electronic device. Positioning the device for proper laser application. Applying a first laser treatment to the electronic device. Removing the electronic device.

### BACKGROUND OF THE INVENTION

Technology is always advancing and has done so at a rapid pace for the last several decades. Technology has become sophisticated, smaller, and accessible across the globe. This has led to technology becoming integral in everyday life. As with any integral element of life, the demand is high. This high demand has led to a rise in the cost of technological devices.

In addition to high demand, the simple replacement of devices can be expensive. If one merely discards older equipment or equipment with minor defects for a brand-new piece the cost can escalate quickly. If, however, technology is upgraded, or repaired this process can be much more cost effective for both the company and consumer.

Refurbishing and reselling mobile devices is a large business. Of course a mobile device must function properly to be resold as a refurbished device. However, another major factor in the sale price is the aesthetics of the device. Many individuals want a refurbished device to appear in like new condition. This means that the device cannot have any scratches or cosmetic defects. One way to ensure that the device has a like new condition is to reapply paint or other coatings to the midframe.

Along with color matching and texture matching part of the difficulty and a large expense is removing the old coatings to allow for the reapplication of the new coating. One method is to manually use grinding and polishing wheels to remove the old coating and prepare the device for repainting. This process uses manual labor and polishing compounds in order to remove the coatings and prepare the midframe for recoating. This process can take a significant amount of time, as long as an hour per device or longer. Further, it is impossible for each device to have a uniform finish. Even with the most skilled humans preforming this process there will still be a nature difference between devices which occurs.

This process can diminish value to a device due to the process differences. These differences can prevent a device from having a proper coating applied. Further, there is an additional cost of the compound supplies and the labor itself. The present system does not seek to replace any human involvement but it does allow for a device to have its coating removed in as little as a few minutes. This means that the through put of a devices can be multiplied by several times. This will raise profitability just by shear numbers of devices. However, the results of using this method also allow for a uniform coating to be applied and for the coating to better resemble a factory finish.

Many companies have been taking advantage of the repair instead of discard philosophy. Further, many consumers are happy purchasing a lightly used and repaired device instead of a brand new one. However, these processes come with new challenges in order to remain effective. Consequently, there is always a need for an improvement in the art.

### SUMMARY OF THE INVENTION

The present invention provides a system and method for applying a laser treatment to an electronic device wherein the same can be utilized for providing an improved system for removing old paint or coloring from an electronic device while also beginning the preparation process for reapplying a coating. The method for applying a laser treatment to an electronic device includes determining the electronic device type. Positioning the device for proper laser application. Applying a first laser treatment to the electronic device. Removing the electronic device.

Another object of the method for applying a laser treatment further includes the step of determining the laser treatment type.

Another object of the method for applying a laser treatment further is to have the laser treatment type comprised of at least one laser pass per side of the electronic device, wherein a laser pass includes the variables of laser pulse rate, laser power, and laser distance traveled between pulses.

Another object of the method for applying a laser treatment is to have the laser treatment type be based on the type of electronic device.

Another object of the method for applying a laser treatment is to have the laser treatment type be based on the material makeup of the electronic device.

Another object of the method for applying a laser treatment further includes the step of applying a second laser treatment to the electronic device.

Another object of the method for applying a laser treatment is to have the positioning the electronic device require the step of determining position of the electronic device based on three planes.

Another object of the method for applying a laser treatment further includes identifying a unique identifier of the electronic device.

Another object of the method for applying a laser treatment is to have the unique identifier be used to retrieve electronic device information from an information management system.

Another object of the method for applying a laser treatment further includes the step of updating the electronic device information in the information management system.

Another object of the method for applying a laser treatment further includes the step of retrieving the electronic device from a specified location.

Another object of the method for applying a laser treatment further includes the step of replacing the electronic device in the specified location.

Another object of the method for applying a laser treatment is to have the laser treatment applied only to the edges of the electronic device.

Another object of the method for applying a laser treatment is to have the laser treatment remove at least 1 micrometer of material from the electronic device.

Another object of the method for applying a laser treatment is to have the laser treatment remove the color from the edge of the electronic device.

Another object of the method for applying a laser treatment further includes the device type be defined as the devices make, model, and color.

Another object of the method for applying a laser treatment is to have a laser treatment comprised of applying a at least one laser pass to each side of the mobile device, and repositioning the phone between each laser pass.

Other objects, features and advantages of the present invention will become apparent from the following detailed description taken in conjunction with the accompanying drawings.

### BRIEF DESCRIPTION OF THE DRAWINGS

The accompanying drawings are incorporated in and are to be considered part of the present specification. These drawings are meant to aid the reader's understanding and comprehension of the present disclosure and are depictions of various example embodiments. The drawings are not to be considered limiting upon the disclosure. It should specifically be noted that the drawings are examples and may not necessarily be drawn to scale.

FIG. 1 shows a block diagram of a computing system.

FIG. 2A shows a front view of an example of a mobile phone device.

FIG. 2B shows a rear view of an example of a mobile phone device.

FIG. 3 shows a perspective view of an embodiment of the system for applying a laser treatment to an electronic device.

FIG. 4A shows a perspective view of an embodiment of several of the components for the system for applying a laser treatment to an electronic device.

FIG. 4B shows a perspective view of an embodiment of several of the components for operating the system for applying a laser treatment to an electronic device.

FIG. 5 shows a flow chart of an embodiment of the method for applying a laser treatment to an electronic device.

### DETAILED DESCRIPTION OF THE INVENTION

For the purposes of presenting a brief and clear description of the present invention, a preferred embodiment will be discussed as used for the system and method for applying a laser treatment to an electronic device. The figures are intended for representative purposes only and should not be considered to be limiting in any respect.

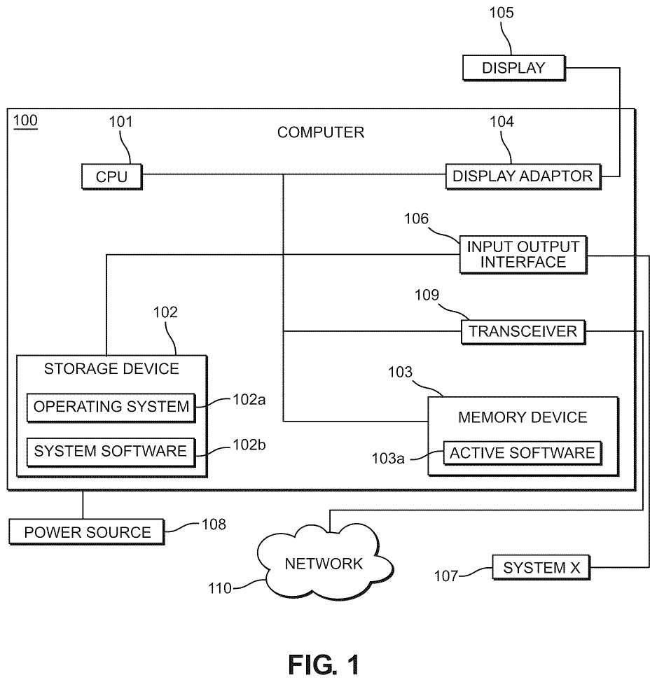

Referring now to FIG. 1, there is shown a block diagram of a computing system. Computing systems may have many interchangeable parts or multiples of some parts. One of ordinary skill in the art will understand that the shown computer 100 is a basic computing system demonstrating a minimal amount of parts to allow for the computer to function. Computer 100 is exemplary, and one of ordinary skill in the art will recognize that computer 100 may be altered as necessary to render the presently disclosed system operable or to provide a peak performance of the disclosed system.

The parts described are each operably coupled together as necessary, one of ordinary skill in the art will understand how to connect general computer components, for example by use of a mother board or other computer board. In the shown embodiment the computer 100 includes a CPU 101. In one embodiment the CPU 101 includes only one processor. In other embodiments the CPU 101 may be made up of multiple processors. Different processors will allow for different computing power and speed.

The computer 100 includes at least one storage device 102. In different embodiments the at least one storage device 102 may be a solid-state storage device, a disk storage device, or another suitable storage device. One of ordinary skill in the art will recognize that there are several types of computing storage devices each providing well-known benefits and drawbacks. The at least one storage device 102 will store at least the computer operating system 102a and system software 102b. System software 102b may include any software necessary, or optionally, used to run any system described herein.

The computer 100 will have at least one memory device 103. One of ordinary skill in the art will recognize that there are several types of computing memory devices each providing well known benefits and drawbacks. The at least one memory device 103 will store at any active software 103a. Active software 103a may include the operating system 102a or parts of the system software 102b. The at least one memory device 103 may store the entire system software 102b size and speed permitting.

The computer 100 may also include various connection ports and types. The computer 100 may have a display adaptor 104. The display adaptor 104 will allow the computer 100 to connect to at least one display 105. In other embodiments multiple displays may be connected to the display adaptor 104. Similarly, the computer 100 may include at least one input/output interface 106. The input/output interface 106 will allow the computer 100 to connect to at least one system, referred to as System X 107 in FIG. 1. The input/output interface 106 may also allow for connection to only part of System X 107 or multiple systems. The computer 100 will also be operably connected to a required power source 108.

The computer 100 may also include a transceiver 109. In one embodiment the transceiver 109 is a wired transceiver. In another embodiment the transceiver 109 is a wireless transceiver. The transceiver 109 will allow the computer 100 to connect to a network 110. The network 110 may be an internet or an intranet connection. The network 110 will allow for the computer 100 to potentially connect to multiple other computing devices. In another embodiment the network may allow for the computer 100 to connect to multiple systems. In one embodiment the computer 100 will allow for System X 107 to be connected to the network 110.

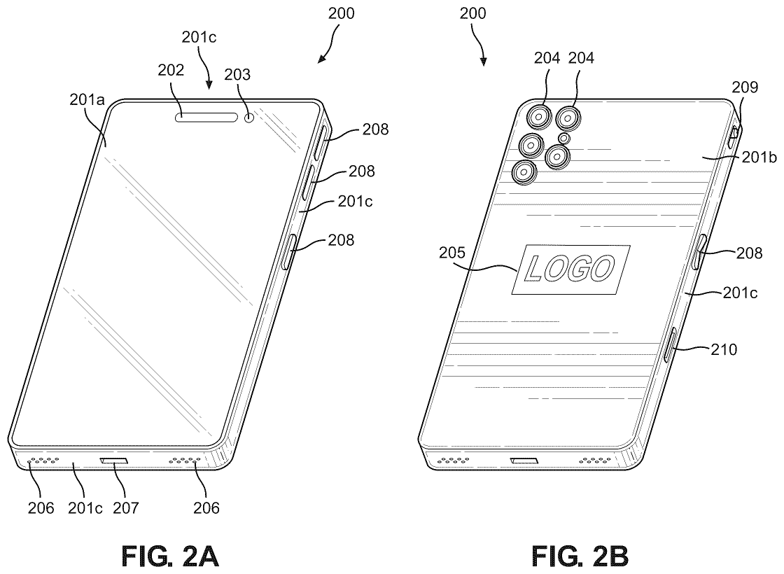

Referring now to FIG. 2A and FIG. 2B, there is shown a front view and a rear view of an example of an electronic device 200, such as a mobile phone device. Electronic devices may have many different parts and components. Even like parts or components may be in various locations or have different shapes and sizes. One of ordinary skill in the art will understand that the shown electronic device 200 is merely an example of the exterior of a device. Any specialized or specific features or requirements of devices will be detailed herein as necessary. However, one of ordinary skill in the art will understand that many electronic devices 200 have many of these described characteristics. Further, electronic devices, such as mobile phone devices, operate on a computer-based platform having many of the computer parts as described in FIG. 1. The below description seeks to detail external components and not the computer which runs the electronic device 200. The electronic device 200 can be, without limitation, a mobile phone device, or a tablet. In one embodiment other electronic devices may be used such as laptops, cable set top boxes, routers, or antennas.

The shown electronic device 200 includes a front surface 201a, a rear surface 201b, and four side surfaces 201c. The front surface 201a typically includes a screen which covers a majority of the surface. The screen is typically covered with a specialized material, currently a glass product. The front surface 201a may also include a speaker opening 202 and a camera opening 203.

The rear surface 201b of the electronic device 200 may include at least one camera lens 204. In the shown embodiment there are a plurality of camera lenses 204. In another embodiment at least one light lens is secured to the rear surface 201b. In many embodiments the rear surface 201b includes a logo 205. The logo 205 may represent the company which created the electronic device 200. The rear surface 201b may include a coating or covering to decorate or protect the rear surface. For example, a coating may be applied to the rear surface 201b to ensure a shiny surface.

The side surfaces 201c of the electronic device 200 may include any or all of the following parts. In one embodiment the electronic device 200 will have several openings for speaker output 206. The electronic device 200 will also include a charging port 207. Charging ports 207 may include a prong therein to secure to a charging cord. An electronic device 200 may include a plurality of buttons 208 along the side surfaces 201c. In different embodiments the plurality of buttons 208 may allow for volume control, locking the electronic device 200, or other desired functions. In some embodiments the electronic device 200 may include a switch 209. In yet another embodiment the electronic device 200 includes a SIM card slot or other card slot 210.

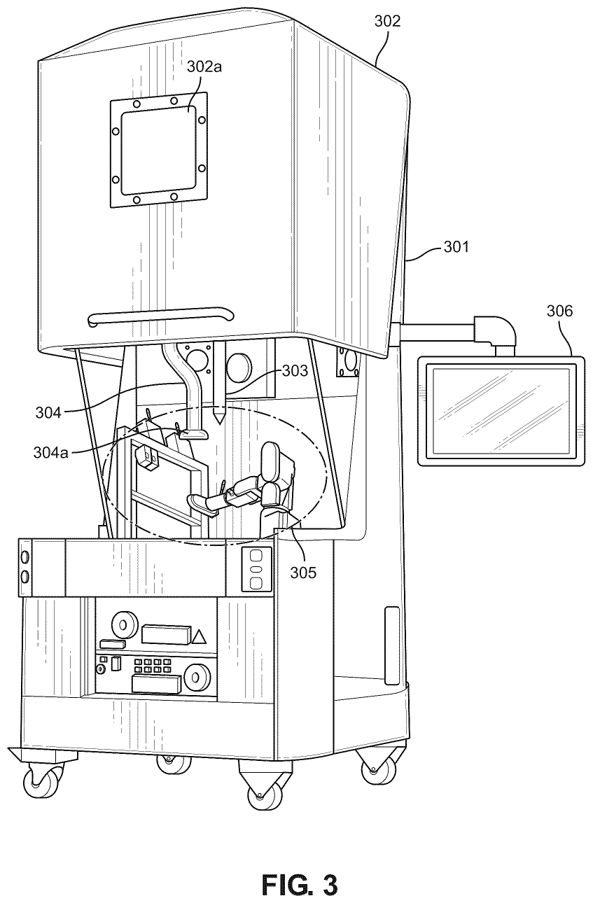

Referring now to FIG. 3, there is shown a perspective view of an embodiment of the system for applying a laser treatment to an electronic device. The system for applying a laser treatment to an electronic device includes a laser housing 301. In one embodiment the laser housing 301 includes a laser hood 302. The laser hood 302 may include a window 302a. In this embodiment the window 302a is specially designed such that a user will still be protected from harmful laser emissions when using the window 302a. In one embodiment the hood 302 is configured to open granting access to the laser location then be closed to protect a user from laser emissions during use. In some embodiments the hood is operably coupled to a safety sensor such that the laser will only activate when the hood 302 is closed.

The laser housing 301 is configured to include various electronics, laser controls, and other components of the system. In different embodiments such laser housings can be purchased from third party suppliers, requiring only a few modifications to function. This does not mean that further modifications, as described below, are not needed, only that lasers can be purchased and are well understood by one of ordinary skill in the art and the exact system need not be detailed here.

The laser housing 301 includes a laser 303. Many different lasers may be used but, any laser used must be capable of removing coatings from desired substrates for the method of use to properly work. In one embodiment a vacuum system is operably coupled with the laser housing 301. The vacuum system includes a vacuum hose 304, ending in a vacuum nozzle 304a. This vacuum hose 304 may be positioned such that as a coating is removed from a substrate the coating dust can be vacuumed away. This will help prevent dust from floating around the laser housing interrupting the laser 303.

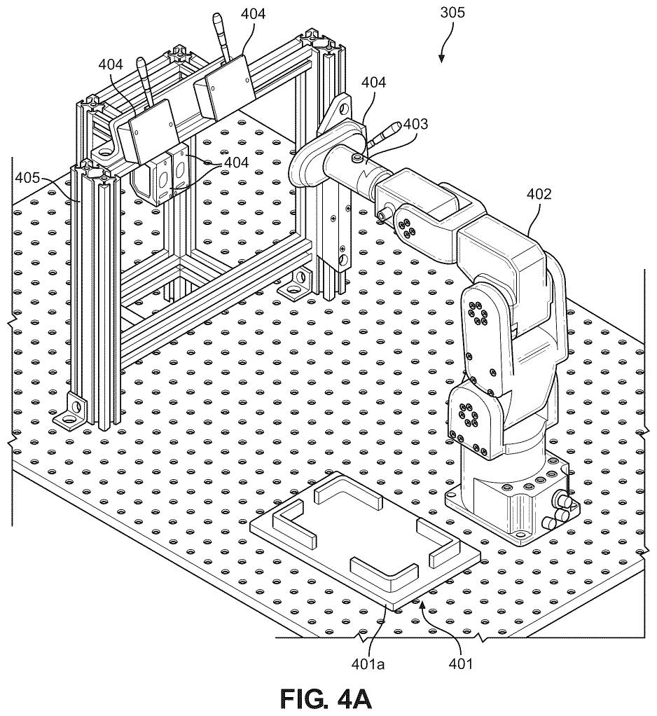

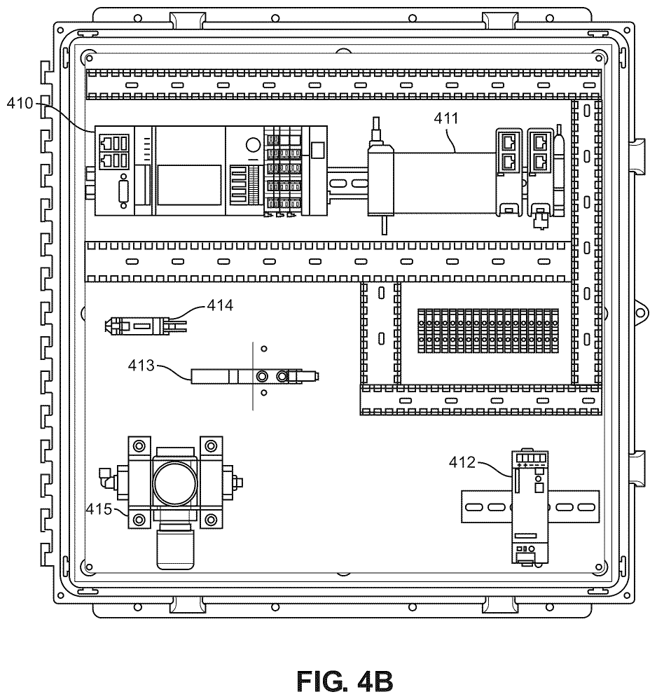

In one embodiment a series of components are included within the laser housing 301 which combined make up a device positioning system 305. The device positioning system will allow for a desired device to properly positioned for a laser treatment to be applied. This device positioning system 305 will be detailed in the description of FIG. 4A.

In some embodiments a screen 306 is operably coupled with the laser system. In one embodiment the screen 306 is only a screen for displaying various information to a user. In this embodiment the laser system is controlled via other controls operably coupled to the laser housing 301. In another embodiment the screen 306 is a touch screen. In this embodiment the screen 306 can be used to control the laser system.

Referring now to FIG. 4A, there is shown a perspective view of an embodiment of several of the components for the system for applying a laser treatment to an electronic device. The device positioning system 305 includes several features. The first is a device platform 401. The device platform 401 includes a base 401a and at least one edge 401b. The at least one edge 401b will allow an operator to position a phone there against ensuring it is in the proper location.

The positioning system 305 also includes a robot arm 402. The robot arm 402 should be capable of retrieving and moving a desired electronic device. Different devices of different sizes and weights may require different type or models of robot arms 402. The robot arm 402 has a device 403 secured to one end which will allow for an electronic device to be picked up and positioned by the robot arm 402.

In one embodiment the device 403 is a vacuum. A vacuum will allow for a device to be picked up by either the front side or the back side. This will enable the laser to apply a treatment to each edge of a device without the need to reposition the device. In other embodiments the device 403 may be an electronic grabber, or other sort of fingers capable of grabbing an electronic device. In the embodiment where a vacuum is used the positioning system 305 will also include air tubes operably coupled with the vacuum.

The positioning system 305 includes a series of positioning sensors 404. The positioning sensors 404 are secured to a bracket 405. In one embodiment there are three positioning sensors 404. In one embodiment there are three sets of positioning sensors 404. Having at least three positioning sensors 404 will allow for a mobile device to be positioned based on three planes. Having sets of positioning sensors 404 will allow for several measurements to be taken from each of the planes. This will ensure that the device is not tilted, and it is only in position at one point.

In one embodiment there are two sets of sensors 404 and a single sensor 404. This will allow for an electronic device to be positioned and squarely placed in a first plane using two sensors 404. Then to be placed squarely in a second plane using the second set of sensors 404. In this case two sensors 404 are required to ensure the electronic device is not tilted or turned in any manner. Ones the first two planes are assured the final sensor can be treated as measurement tool to ensure the electronic device is placed a specific distance from the single sensor 404 and thus properly placed in the third plane.

Referring now to FIG. 4B, there is shown a perspective view of an embodiment of several of the components for operating the system for applying a laser treatment to an electronic device. In addition to the components housed in the laser housing several additional components may be used to ensure proper functionality. In one embodiment these components can be added to the laser housing. In another embodiment the components are housed in a secondary chamber and are operably coupled to the laser housing.

The additional components include a computer or programmable logic controller (PLC) 410. The PLC 410 is used to control the laser including operating programs for properly applying the laser treatment to an electronic device. The PLC is operably coupled to a sensor controller 411. The sensor controller 411 is operably coupled to the positioning sensors as described above. Each of the components described herein are operably coupled to a power supply 412 as necessary. The power supply 412 will supply the necessary power to each of the components.

In addition to the electrical components, several air components are included. The air components include a vacuum valve 413. The vacuum valve 413 is used in the embodiment where the electronic device is picked up by the robot arm using a vacuum. The vacuum valve 413 will be operably coupled via air hoses in order to apply the necessary pressure to the device.

In addition to the vacuum valve 413 there is a pressure sensor 414 and a pressure regulator 415. The pressure sensor 414 is operably coupled to the pressure regulator 415. The pressure regulator 415 will ensure that proper vacuum pressure is applied to the electronic device.

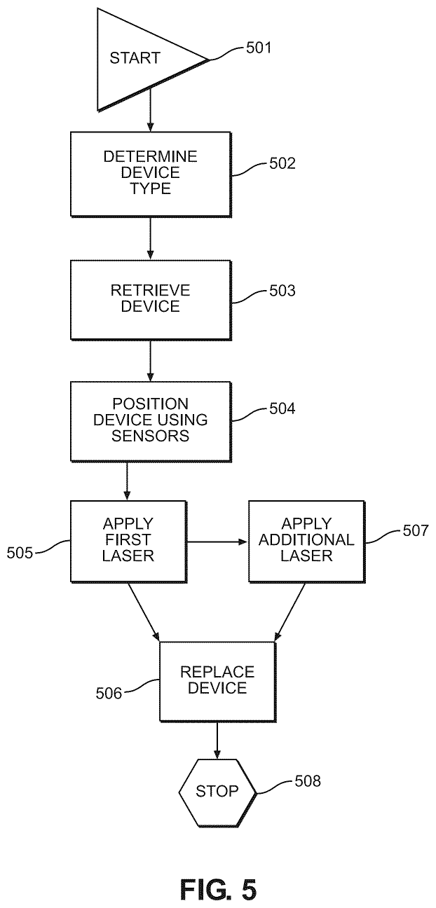

Referring now to FIG. 5, there is shown a flow chart of an embodiment of the method for applying a laser treatment to an electronic device. The method for using the laser machine for applying the laser treatment to an electronic device starts 501 by determining the device type 502. For example, the system may need to determine what type of device is to be lasered, for example, iPhone®, Kindle®, Surface®, or another type of device. In some embodiments the method proceeds directly to the next step and the device is retrieved. In other embodiments the device type may include one or more items selected from the group of the devices make, the devices model, and the devices color.

Once the device type is determined 502 the system will be able determine the laser treatment type 502a. The laser treatment type may depend on items such as specific location of buttons of the electronic device or the device's color, number of locations to be lasered, or device material. In one embodiment a laser treatment type is made up of a combination of laser passes per location. In various embodiments the laser pass includes defining variables selected from the group of: laser pulse rate, laser power, and laser distance traveled between pulses. In some embodiments a laser treatment is made up of lasering multiple locations. In these embodiments different variables may be applied to each location. Once the laser treatment type is determined the system for applying the laser treatment to an electronic device can load the proper instructions via computer components, allowing for proper lasering of the device.

In many embodiments a laser treatment type and thus the number of laser passes will be determined by the type of device. Once the device type is known the number of passes, laser variables, and number of locations can be determined to make up the laser treatment. After the instructions are loaded the device is retrieved 503. In the present embodiment when a device is retrieved 503, the device has been placed in the positioning bracket and the robot and vacuum retrieves the device. However, in some embodiments the method does not need to make use of the described device as there are other potential ways to apply a laser treatment to a device.

After the device is retrieved 503 it must be properly positioned 504 in order for the laser to properly apply the treatment. In one embodiment devices are picked up in the same manner every single time. Therefore, the robot will be able to immediately properly position the device. In other embodiments it can be difficult to ensure exact placement of a device every time one is retrieved. In some instances proper placement is a necessity as being off by even a few millimeters can cause a device to be destroyed by the laser application. Using the described machine two pairs of location sensors properly square the device under the laser for application of the laser treatment.

After the device is properly positioned 504, the laser treatment is applied to a first location 505. In one embodiment the laser moves along a predetermined route to properly apply the laser to the first location. In one embodiment this step includes adjusting the lasers pulse rate, movement speed along the first location, and laser Watts. In some embodiments, a laser treatment may include multiple passes along the first location. In addition, each pass may be done having different values for the variables discussed above.

After the laser treatment has been applied to the first location 505 the device may be replaced in the device platform 506. In another embodiment additional laser treatments can be applied to additional locations 507. In this embodiment the laser treatment can be the same treatment as applied in step 505. There is no limitation requiring the treatments to be the same however, and the variables may change in order to apply a different treatment to any additional locations. In some embodiments when the first location and any additional locations are part of a single option these changes in variables are still considered a single treatment. After laser treatments are applied to the additional locations 507 the device is then placed back in the device platform 506 and the method ends.

It is therefore submitted that the methods, systems, and devices have been shown and described in what is considered the most practical and preferred embodiments along with specific examples. It is recognized, however, that departures may be made within the scope and these present examples are not intended to be limiting. One of ordinary skill the art will be able to discern that obvious modifications can be made without departing from the scope or spirit.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Similarly, it is to be realized that, it is not intended for any method set forth herein to be construed as requiring that its steps be performed in a specific order, unless otherwise set forth in the claims.

Therefore, the foregoing is considered as illustrative only of the principles of the disclosure. Further, since numerous modifications and changes will readily occur to those skilled in the art, it is not desired to limit the invention to the exact construction and operation shown and described, and accordingly, all suitable modifications and equivalents may be resorted to, are deemed to fall within.

1. A method for applying a laser treatment to an electronic device, comprising:
determining the electronic device type;
positioning the device for proper laser application;
applying a first laser treatment to the electronic device;
removing the electronic device.

2. The method for applying a laser treatment of claim 1, further comprising determining the laser treatment type.

3. The method for applying a laser treatment of claim 2, wherein the laser treatment type is comprised of at least one laser pass per side of the electronic device, wherein a laser pass includes the variables of laser pulse rate, laser power, and laser distance traveled between pulses.

4. The method for applying a laser treatment of claim 2, wherein the laser treatment type is based on the type of electronic device.

5. The method for applying a laser treatment of claim 2, wherein the laser treatment type is based on the material makeup of the electronic device.

6. The method for applying a laser treatment of claim 1, further comprising applying a second laser treatment to the electronic device.

7. The method for applying a laser treatment of claim 1, wherein positioning the electronic device requires determining position of the electronic device based on three planes.

8. The method for applying a laser treatment of claim 1, further comprising identifying a unique identifier of the electronic device.

9. The method for applying a laser treatment of claim 8, wherein the unique identifier is used to retrieve electronic device information from an information management system.

10. The method for applying a laser treatment of claim 9, further comprising updating the electronic device information in the information management system.

11. The method for applying a laser treatment of claim 1, further comprising retrieving the electronic device from a specified location.

12. The method for applying a laser treatment of claim 11, further comprising replacing the electronic device in the specified location.

13. The method for applying a laser treatment of claim 1, wherein the laser treatment is applied only to the edges of the electronic device.

14. The method for applying a laser treatment of claim 1, wherein the laser treatment removes at least 1 micrometer of material from the electronic device.

15. The method for applying a laser treatment of claim 1, wherein the laser treatment removes the color from the edge of the electronic device.

16. The method for applying a laser treatment of claim 1, wherein device type is defined as the devices make, model, and color.

17. The method of claim 1, wherein a laser treatment is comprised of applying a at least one laser pass to each side of the mobile device, and repositioning the phone between each laser pass.
